(19) United States
(12) Patent Application Publication
(10) Pub. No.: US 2016/0125529 A1
(43) Pub. Date: May 5, 2016

(54) SYSTEM AND METHOD FOR REAL-TIME CHARGEOFF MONITORING

(71) Applicant: MasterCard International Incorporated, New York, NY (US)

(72) Inventor: Arun Acharya, Tuckahoe, NY (US)

(73) Assignee: MasterCard International Incorporated, New York, NY (US)

(21) Appl. No.: 14/531,788

(22) Filed: Nov. 3, 2014

(51) Int. Cl. G06Q 40/02

(52) U.S. Cl. CPC G06Q 40/025

(57) ABSTRACT

A payment network for real-time chargeoff monitoring includes a server and at least one memory module storing computer program code. The at least one memory module and the stored computer program code are configured to, with at least one processor, cause the server to receive a set of credit bureau files and a set of transaction processor files. Further the memory module, computer program code, and the processor are configured to cause the server to process the credit bureau files, the transaction files, and payment card information associated with a set of payment cards, through a chargeoff model to determine a set of chargeoff scores. Each of the chargeoff scores is associated with one of the payment cards. The memory module, computer program code, and the processor are also configured to cause the server to receive a credit-limit-increase request message. The credit-limit-increase request message includes a credit-limit increase request for a subject card selected from the set of payment cards. The server receives the credit-limit-increase request message from a subject issuer that issued the subject card.

### TECHNICAL FIELD

This disclosure relates generally to the field of electronic transaction processing, and more specifically to systems and methods for implementing real-time chargeoff monitoring.

### BACKGROUND

As is well known in the art, a payment network may direct or process cashless transactions (or card-based transactions) by facilitating interactions between a payment card issuer and a merchant bank. For example, in a typical card-based payment system transaction, a cardholder presents a credit/debit/prepaid card to a merchant for the purchase of goods and/or services. It is understood that prior to the occurrence of such a transaction, the cardholder was issued the card by an issuing bank or financial institution. Moreover, it is understood that the merchant has established a relationship with an acquiring bank, thereby allowing the merchant to receive credit/debit cards as payment for goods and/or services, or to complete any type of purchase transaction. That is, merchant banks and issuing banks may make use of various payment networks. One such payment network is operated by MasterCard International Incorporated, the assignee of the present disclosure.

As part of above-referenced transaction, after the cardholder presents a card to the merchant, the merchant may send an authorization request to the acquiring bank via, for example, a point-of sale (“POS”) terminal located at or otherwise controlled by the merchant. In turn, the acquiring bank communicates with the payment network, and the payment network communicates with the issuing bank to determine whether the cardholder is authorized to make a transaction. The issuing bank either approves or disapproves the authorization request and thereafter transmits the response back to the merchant. The merchant may then either complete or cancel the transaction based upon the response to the authorization request.

If the transaction is approved, the transaction amount will be sent from issuing bank through the payment network to the acquiring bank. The transaction amount, minus certain fees, will thereafter be deposited within a bank account belonging to the merchant, in accordance with a process called clearance. The issuing bank thereafter bills the cardholder for all transactions conducted over a given period of time by sending a cardholder statement to the cardholder. The cardholder follows by submission of payments to the issuing bank. This submission of payments by the cardholder may be automated (e.g., in the case of debit transactions), may be initiated by the cardholder for the exact amount matching amounts of purchases during the statement period (e.g., charge cards or credit balances paid in full), and/or may be submitted (in part or in whole) over a period of time that thereby reflects the amount of the purchases, plus any financing charges agreed upon beforehand between the cardholder and the issuing bank (e.g., revolving credit balances). Examples of issuing banks include traditional banks and also credit unions and the like.

Typically, credit bureaus (e.g., Equifax®, Experian®, and TransUnion®) and transaction processors (e.g., TSYS Merchant Solutions^{SM}, FirstData™, and the like) gather and maintain transaction information relating to credit transactions. For example, credit bureaus gather information from card issuers, as well as other sources. Similarly, transaction processors gather information from merchants/vendors when, for example, the transaction processor sends the transaction information to the payment network. Because credit-bureau information is typically provided to issuers on a periodic basis, such as through quarterly or months submissions (e.g., because the credit bureau receives such payment submission from numerous banks/issuers according to statement cycles, etc.).

It is also to be understood that a cardholder may be issued a number of cards from a number of issuing banks. As the cardholder uses the card and builds credit with the issuer, the cardholder may wish to increase the credit limit associated with the card, and may request the issuer to do so. Before approving the request for the increased credit limit, the issuing bank may wish to evaluate risk associated with the cardholder using the exploiting increased credit limit to run up a large amount of credit debt using the card and then (either intentionally or unintentionally) charging off the credit debit—that is, by not paying back the debt to the issuing bank. This risk is referred to as chargeoff risk. Chargeoff risk may be reflected by an analysis of a cardholder's general financial behavior respecting credit—e.g., by taking into account information relating to one or more cards issued to the cardholder by various issuers. Accounting for such information, however, may be difficult for the issuer because the information is spread across disparate sources.

Moreover, an evaluation of chargeoff risk may become stale quickly where a cardholder seeks to increase the limit of multiple cards at the same time (e.g., where such a spike of activity evades the slow information cycle associated with credit-bureau data). This is because card issuers using conventional payment network systems have a limited ability to evaluate chargeoff risk. This may be based on the card issuers having incomplete information regarding the cardholder and cards associated with the cardholder. For example, as referenced above, the credit bureau information available to the issuer may be stale at the time the cardholder requests the credit-limit increase, particularly with regard to the cardholder's cards from other issuers. And, for example, while issuers are able to receive daily transaction files from transaction processors, transaction processors are not able to link transaction information to the associated card holder. This incomplete information may mask a cardholder's poor financial health or poor credit behavior, thus subjecting the issuer to chargeoff risk. This masking effect may be enhanced where a cardholder holds a number of cards from different issuers, and where the cardholder has had relatively good credit behavior until just before the cardholder requests the limit increase (e.g., until within a few weeks of the request).

### BRIEF SUMMARY OF THE DISCLOSURE

In light of the above-described shortcomings of conventional payment network systems, there exists a long-felt need for a payment network system that integrates various sources of information, including credit bureau information and transaction processor information. In particular, there is a need for such a payment network system that applies the integrated information to a rule-based chargeoff model that enables card issuers to evaluate chargeoff risk associated with a credit-limit-increase (“CLI”) request. Such an integrated payment network system may use robust credit behavior data related to the cardholder, and across a large sample of cardholders, and may also have information that is up-to-date and that is linked to the cardholder requesting the CLI, even across cards issued by numerous issuers. Further, such a payment network may run this complete information through a chargeoff model and provide a card issuer with an intelligent estimate of chargeoff for potential debt accumulated on the card pursuant to the requested increase in credit limit.

The present disclosure includes a payment network system with a payment network that receives and integrates information from credit bureaus and transaction processors. In the payment network system, an issuer may request a CLI for a card the issued by the issuer. This may be done, for example, in response to a similar request that a cardholder submits to the issuer. The card for which the issuer requests the CLI is referred to herein as the subject card. Similarly, the issuer of the subject card and from which the cardholder requests the CLI is referred to herein as the subject issuer. Further, cards issued by issuers other than the subject issuer are referred to herein as secondary cards. And the issuers of secondary cards are referred to herein as secondary issuers. Moreover, in the event that other nomenclatures are used herein, one of skill in the art, having read this disclosure, will understand from the context thereof whether the disclosure is referring to the subject card and/or subject issuer, or to some other card or issuer.

A card, or payment card, as used herein, may refer to a conventional magnetic-stripe credit, debit card, or similar proximity payment device (used on its own or incorporated into another device such as a smartphone, tablet, etc.) having, for example, near field communications (“NFC”) capabilities, such as a radio frequency identification (“RFID”) chip, implemented therein. A card may further refer to virtual or limited-use account numbers and to electronic wallets. The card subject to the CLI is referred to herein as the subject card. Moreover, the issuer of the subject card is referred to as the subject issuer.

As referred to above, having complete and up-to-date information readily available, the payment network may integrate that information and, based on a robust sample set of cardholders, may construct a chargeoff model to generate a chargeoff score associated with a CLI. The chargeoff model may be rule-based, that is, the chargeoff score may be determined according to a set of chargeoff rules. The chargeoff rules may be associated with thresholds that the payment network system uses for bases of comparison with the integrated information. Based on the comparison of the integrated information with the chargeoff rules, the chargeoff model may generate a set of binary subscores, each binary subscore being associated with one of the chargeoff rules and having a value of either 0 or 1, depending on the comparison. Further, the chargeoff model may apply a weighting to each of binary subscores according to a set of rule weightings, each corresponding to one of the chargeoff rules. In this manner, and by summing the weighted binary subscores, the chargeoff model may receive as input the integrated information and provide as output the chargeoff score. The chargeoff score may be a number ranging from 0 to 1 (inclusive), and may represent a risk that a cardholder will chargeoff the debt associated with a payment card.

The payment network may, in response to receiving the CLI from the subject issuer, provide the chargeoff score and/or a recommendation based thereon, to the subject issuer. As such, the subject issuer may decline the cardholder's CLI request after receiving the chargeoff score and/or recommendation from the payment network. In sum, the payment network system described herein integrates disparate information and processes that information through a robust chargeoff model. This rule-based chargeoff model enables issuers, such as financial institutions, to monitor chargeoff risk, and thereby avoid cardholder exploitation of limit increases by eliminating (or reducing) gaps in information available to issuers participating in the disclosed payment network system. By contrast, issuers participating in conventional payment network systems are exposed to chargeoff risk through the gaps in the available information, including, by way of example, lack of accuracy, lack of timeliness, and shortage of information.

In one embodiment of a payment network for real-time chargeoff monitoring, the payment network includes a server and at least one memory module storing computer program code. The at least one memory module and the stored computer program code are configured to, with at least one processor, cause the server to perform a series of computing and processing functions in the payment network, as follows. The server is caused to receive a set of credit bureau files from one or more credit bureaus and a set of transaction processor files from one or more payment transaction processors.

Further, the server is caused to process the credit bureau files, the transaction processor files, and payment card information associated with a set of payment cards, through a chargeoff model to determine a set of chargeoff scores. The chargeoff scores are each associated with one of the payment cards, and the chargeoff model includes a set of chargeoff rules. In one implementation of the payment network system, the chargeoff model receives as input a set of chargeoff parameter values associated with one of the payment cards, and produces as output the chargeoff score associated with the payment card. Additionally the server is caused to receive a credit-limit-increase request message that includes a credit-limit increase request for a subject card selected from the set of payment cards. The credit-limit-increase request message is received from a subject issuer that issued the subject card.

In an additional embodiment of the payment network, the at least one memory module and the computer program code are further configured to, with the at least one processor, cause the server to generate a credit-limit-increase response message. In one instance, the credit-limit-increase response message includes a denial suggestion for the credit-limit increase request if a subject chargeoff score is greater than or equal to a predetermined threshold. The subject chargeoff score is the chargeoff score associated with the subject card. Further, the credit-limit-increase response message includes an approval suggestion for the credit-limit-increase request if the subject chargeoff score is less than the predetermined threshold.

The subject chargeoff score, in some embodiments, represents a risk of chargeoff for the subject card issued by a subject issuer. In such embodiments, the subject card is associated with a cardholder and the risk of chargeoff is based on the cardholder's activity associated with the subject card and with a one or more secondary cards issued to the cardholder by one or more secondary issuers. The secondary issuers in this embodiment are financial institutions other than the subject issuer.

In a further embodiment of the disclosure, the at least one memory module and the stored computer program code are further configured to, with the at least one processor, cause the server to receive the credit-limit-increase request message via a hosted online platform. The hosted online platform may include a graphical user interface that receives issuer input. In one instance of the disclosure, the server receives the credit-limit-increase request message from the subject issuer. Further to this instance, the at least one memory module and the stored computer program code are further configured to, with the at least one processor, cause the server to generate a modified chargeoff model based on the issuer input, to determine a set of modified chargeoff scores based on the modified chargeoff model.

### BRIEF DESCRIPTION OF THE DRAWINGS

The present disclosure is illustrated by way of example, and not limitation, in the figures of the accompanying drawings, in which:

FIG. 1 illustrates an example payment network system for real-time chargeoff monitoring;

FIG. 2 illustrates an additional example payment network system for real-time chargeoff monitoring;

FIG. 3 illustrates an example method for real-time chargeoff monitoring; and

FIG. 4 illustrates an example computing module that may be used to implement features of various embodiments of the disclosure.

### DETAILED DESCRIPTION

The present disclosure is directed to systems and methods for real-time chargeoff monitoring and to various embodiments of such systems and methods.

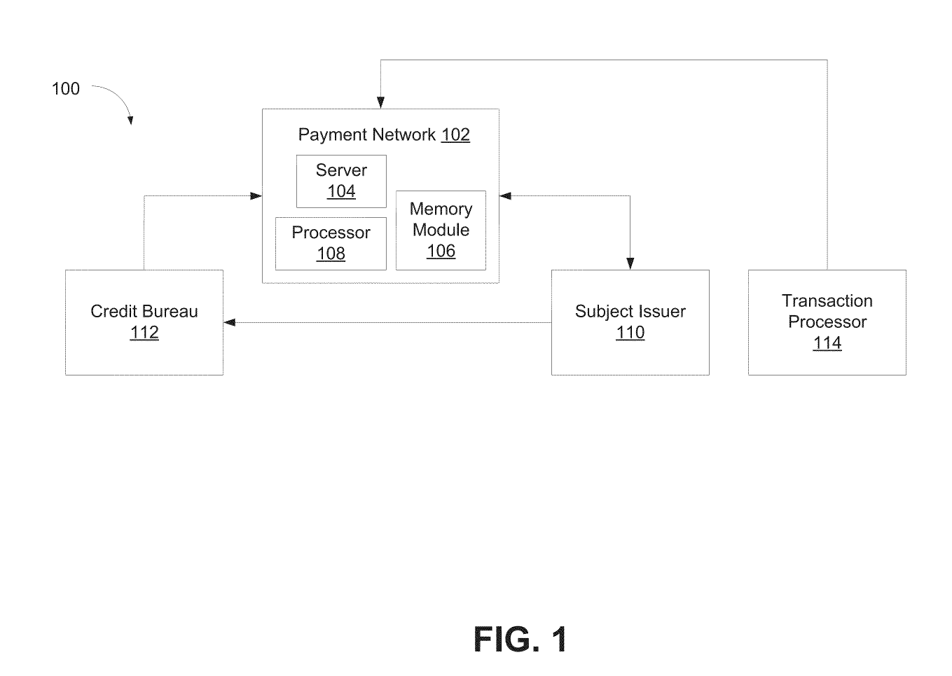

As illustrated in FIG. 1, one embodiment of the disclosure includes payment network system 100 for real-time chargeoff monitoring. As shown, payment network system 100 includes payment network 102, subject issuer 110, credit bureau 112, and transaction processor 114. A payment network such as payment network 102 may be maintained and operated by a payment card network that facilitates cashless transactions. An example of such a payment network is MasterCard International Incorporated, the assignee of the present disclosure. In payment network system 100, payment network 102 receives data from credit bureaus 112 and from transaction processors 114. Payment network 102 may integrate this data, which is gathered in some instances from disparate sources, and may use the data to generate robust analytic models, such as a chargeoff model for determining the probability that a cardholder will chargeoff a credit account. Further, payment network 102, with specifically configured server 104, memory modules 106, and processors 108, may make such analytic models available to financial institutions to further add value to payment network system 100.

One example creating such a value-added payment network includes configuring payment network 102 to receive a credit-limit-increase request message from a subject issuer 110 (e.g., a financial institution), to parse information from the message, and to process that information through the chargeoff model to determine a chargeoff score. The subject issuer may then use the chargeoff score to disposition credit-limit-increase requests from the subject issuer's 110 cardholders. Alternatively, payment network 102 may determine a set of chargeoff scores in advance of receiving a credit-limit-increase request, each of the chargeoff scores corresponding to one of a set of payment cards, and may provide a subject chargeoff score in response to receiving a CLI request message related to a subject card selected from the set of payment cards.

Moreover, because of the robust dataset processed by payment network 102, subject issuer 110 may disposition credit-limit-increase requests based on data previously unavailable on a real-time basis (without trading off the accuracy of the data). Accordingly, the embodiments disclosed herein are directed to a payment network system 100 for real-time chargeoff monitoring that increases the speed with which issuers may disposition credit-limit-increase requests, increases the accuracy of such dispositions, and decreases the costs associated therewith.

The elements of payment network system 100 may interact with one another via a communication medium (e.g., as represented by the various arrows in FIG. 1). The communication medium may be implemented in a variety of forms. For example, the communication medium may include an Internet connection, such as a local area network (“LAN”), a wide area network (“WAN”), a fiber optic network, internet over power lines, a hard-wired connection (e.g., a bus), and the like, or any other kind of network connection or series of network connections. Further, example implementations of the communication medium may include any combination of routers, cables, modems, switches, fiber optics, wires, radio, and the like. The communication medium may also be implemented using various wireless standards, such as Bluetooth, Wi-Fi, 4G LTE, and the like. One of skill in the art will recognize other ways to implement the communication medium for communications purposes, and with specific regard to the elements of payment network system 100.

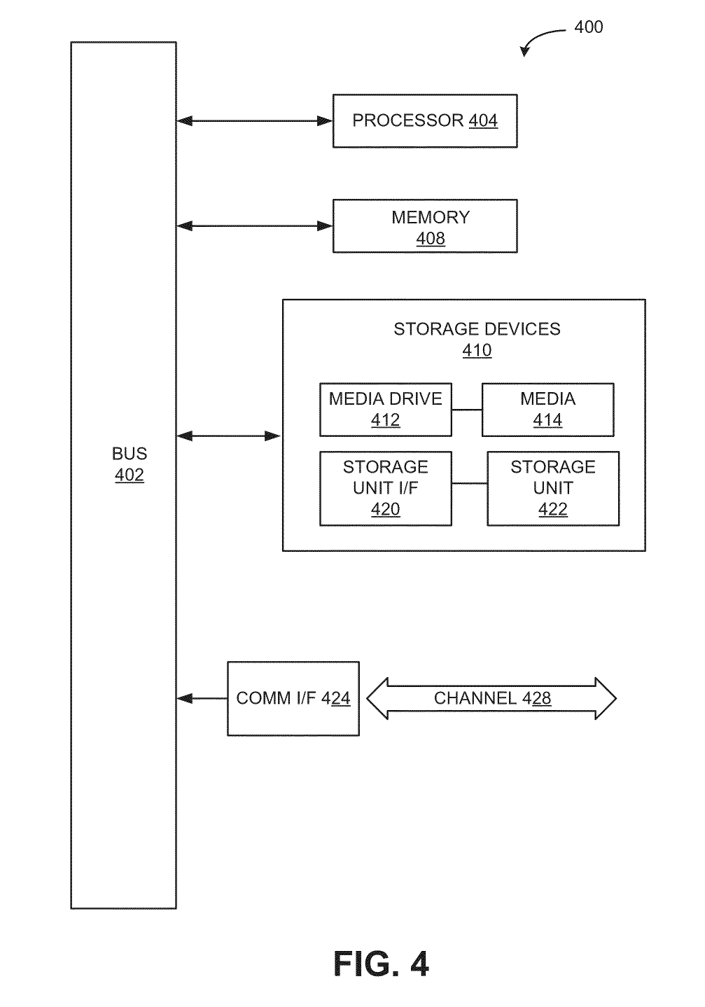

Payment network 102, in various embodiments, directs or processes cashless transactions (or card-based transactions) by facilitating interactions between a payment card issuer and a merchant bank, as alluded to above. In one embodiment of payment network system 100, payment network 102 includes server 104, at least one memory module 106, and processor 108. Server 104 may direct communications made over the communication medium. Server 104 may be, for example, an Internet server, a router, a desktop or laptop computer, a smartphone, a tablet, a processor, a module, or the like. In one embodiment, server 104 directs communications between the communication medium and memory module 106 and/or processor 108. For example, server 104 may update information stored on memory module 106, or server 104 may execute instructions received over the communication medium in real time. Memory module 106 stores computer program code. Memory module 106 may be, for example, a magnetic hard drive, a solid-state drive, a database, cloud-computing storage, cache, and the like, and will be further described below with regard to FIG. 4.

Memory module 106 and the stored computer program code are configured to, with at least processor 108, cause server 104 to receive a set of credit bureau files from one or more credit bureaus 112 and a set of transaction processor files from one or more payment transaction processors 114. For example, subject issuer 110 may issue a payment card to a cardholder. The payment card may be any type of card, as described, by way of example, hereinabove. The cardholder may then start using the payment card with various merchants to complete purchase transactions. These purchase transactions and card activities generate information that is gathered by credit bureau 112 and/or transaction processor 114, in a fashion similar to that described hereinabove.

Credit bureau 112 may obtain transaction and other financial information from subject issuer 110, and from the secondary issuers of secondary cards held by a cardholder. This transactional and other financial information may thus be related to one or more cards issued to the cardholder. Such information may include, for example, the identification of the cardholder to whom the card was issued (e.g., name, address, phone number, e-mail address, etc.); the account number of the card and other identifying numbers associated with the card; the balance of the card, including average balance over time; the average payment amount; the amount receivable at the next statement date; the minimum payment amount and due date therefor; and other similar information associated with the cardholder's account with the issuer. Additional information gathered by credit bureau 112 may include credit product type—e.g., when the credit account is not associated with typical consumer debt but includes mortgage debt, education loans, car loans, and the like.

Credit bureau 112 may gather this information and organize, maintain, and update the information in credit bureau files. Credit bureau 112 may maintain a credit bureau file for each card holder. The credit bureau files, based on the above-described information gathered by credit-bureau 112, may include linkage data that links transactions associated with cards to cardholders' identities. As describe above, in some instances, server 104 of payment network 102 receives credit bureau files periodically, as credit bureaus 112 typically only update the credit bureau files when the cardholder's payment statement period ends for the particular card. So, for example, the credit bureau file regarding the subject card for the subject cardholder may be updated monthly or quarterly, but typically is not updated as frequently as daily. Though credit bureau 112 is described, in some instances, in terms of a single credit bureau, one of skill in the art will recognize, upon reading the disclosure, that payment network system 100 may include multiple credit bureaus 112, and such is encompassed and enabled by the disclosure.

Transaction processor 114 may obtain transaction and other financial information from merchants with whom the card is used to complete payment transactions, or from the acquiring banks of those merchants. Transaction processor 114 receives transactional information related to each transaction completed using the card issued to the cardholder. Such information may include, for example the account number of the card and other identifying numbers associated with the card; a credit limit associated with the card; a daily balance associated with the card; the current balance of the card; average balance over time; a delinquency status of the card (e.g., that indicates frequency or amount of delinquency, past cycles due, past days due, etc.); a status of the card (e.g., open, closed, stolen, fraudulent activity); open date of the card (e.g., the date the card or associated payment account was activated by the issuer); the minimum payment amount and due date therefor; and other similar information associated with the cardholder's account maintained by the issuer, and/or with transactions completed using the card.

Transaction processor 114 may gather this information and organize, maintain, and update the information in transaction processor files. Transaction processor 114 may maintain a transaction processor file for each card. The transaction processor files, based on the above-described information gathered by transaction processor 114, typically do not include linkage data that links transactions associated with one or more cards to cardholder identity. As described above, in some instances, server 104 of payment network 102 receives the transaction processor files periodically as the information is received from merchants, acquiring banks, and so on. So, for example, the transactional processor file regarding the card may be updated on a daily basis, or on a less frequent basis, or more frequently, in some instances. Though transaction processor 114 is described in terms of a single transaction processor, one of skill in the art will recognize, upon reading the disclosure, that payment network system 100 may include multiple transaction processors, and such is encompassed and enabled by the disclosure.

Server 104 of payment network 102 receives credit bureau files and transaction processor files, and processes the credit bureau files and transaction process files. Processing the files may include, for example, parsing the credit bureau files and transaction processor files to determine payment card information, and to organize all the other information described above in the credit bureau files and the transaction processor files into payment card profiles. The credit bureau files or the transaction processor files may include historical data for each cardholder, or for each payment card. The historical data may, by way of example, extend back for 2 years or more. Additionally, payment card information may be received from issuers, for example. Each of the payment card profiles may be processed through the chargeoff model created by payment network 102 to determine a set of chargeoff scores, each associated with one of the payment card profiles.

The chargeoff model includes a set of chargeoff rules, for example stored in memory module 106. The set of chargeoff rules may typically be related to financial metrics associated with payment card profiles. Moreover, each of the chargeoff rules in the set of the chargeoff rules typically indicates, based on the financial metric embodied in the chargeoff rule, a likelihood or lack thereof that the cardholder of the payment card is at risk for chargeoff. In one illustrative instance of payment network system 100, the chargeoff model receives as input a set of chargeoff parameter values associated with one or more of the payment cards. The set of chargeoff parameters may correspond to the payment card information received in the credit bureau files or the transaction processor files—e.g., status of the card, open date of the card, the balance of the card, and so on, as described above. The chargeoff model processes the chargeoff parameter values by comparing the chargeoff parameter values to the set of chargeoff rules, described below, and then produces the chargeoff score as output. This may be repeated numerous times of each of the payment cards described in the credit bureau files and/or the transaction processor files. Server 104 may then further process the chargeoff scores to generate a CLI response messages, as described below.

The following lists non-limiting examples of chargeoff rules that may be related to financial metrics: (1) number of times the account is days past due (and further what that number of days past due is over a past time period); (2) card status; (3) utilization of the card (e.g., average daily balance divided by credit limit); (4) number of times the minimum payment of the card is not met in a defined time period; (5) number of fraud transactions against the card; (6) ratio of revolving credit card balance to credit limit; (7) whether card holder has missed a payment for other credit cards across issuers in a defined time period; (8) number of hits against a card holder (e.g., credit pulls); (9) credit bureau reports that the cardholder's credit score is less than a predetermined threshold; (10) number of installment loan closures, bankruptcies, and/or chargeoff occurrences, including for different issuers and in different defined time periods; (11) comparison of estimated income to average debt on the payment card or overall across several credit instruments; (12) whether the cardholder has requested a CLI for another of the cardholders card, and/or the disposition of the CLI, including the amount of the requested increase or amount granted; and so on. The chargeoff rules, in addition to contributing to the chargeoff score, may trigger a flag for the issuer that the cardholder presents a chargeoff risk. The flag may indicate that the subject issuer should deny the CLI request, that the subject issuer should seek additional information from cardholder 216, etc.

Server 104 processes the credit bureau files, the transaction processor files, and payment card information associated with each of the set of cards, through the chargeoff model. In this manner, server 104 may determine a set of chargeoff scores from the chargeoff model, based on a comparison of the files and payment card information, to the set of chargeoff rules implemented in the chargeoff model. In one embodiment, server 104 updates the chargeoff score associated with each payment card for which payment network 102 receives files or information. For example, upon receiving a transaction processor file that contains information about transactions completed using a particular card, server 104 updates the chargeoff score associated with that payment card. In such an embodiment, payment network 102 maintains numerous running chargeoff scores, each associated with a payment card. This embodiment may serve as an example of payment network 102 maintaining a real-time chargeoff score.

The cardholder may request an increase in the cardholder's credit limit for a subject card. The cardholder may initiate this request to the subject issuer in a number of ways. For example, the cardholder may call the subject issuer on the telephone to request the CLI from an employee of the subject issuer, may initiate a chat session, may log in to a website of the subject issuer, and so on. Upon receiving the request for an increased limit from the cardholder, the subject issuer may wish to disposition the request (e.g., grant or deny), but before doing so, may wish to determine whether and what chargeoff risk is associated with the subject payment card and/or the cardholder. Though some issuers maintain conventional decision models for dispositioning CLIs, these decision models suffer from the conventional lack of integrated information and lack of recent information, and typically sacrifice timeliness to gain accuracy. Upon receiving the CLI request from the cardholder, the subject issuer may use the chargeoff model of payment network 102 to obtain a chargeoff risk or a subject chargeoff score associated with the subject card, or to obtain a suggestion for dispositioning the CLI based on the chargeoff risk or subject chargeoff score.

To use the chargeoff model of payment network 102, the subject issuer may “ping” or send a CLI request message to payment network 102. Server 104 may be configured to receive a CLI request message that includes a CLI request for a subject card issued to a cardholder by the subject issuer. For example, memory module 106 and computer program code stored thereon, may be configured to, along with processor 108, cause server 104 to receive the CLI request message over the communication medium described above. Server 104, in one instance of payment network system 100, receives the CLI request message via a hosted online platform. For example, payment network system 100 may include a hosted online platform maintained by payment network 102. Subject issuer 110 may access the hosted online platform to submit a CLI request message to payment network 102 to obtain a subject chargeoff score that reflects the risk of chargeoff, according to the chargeoff model of payment network 102.

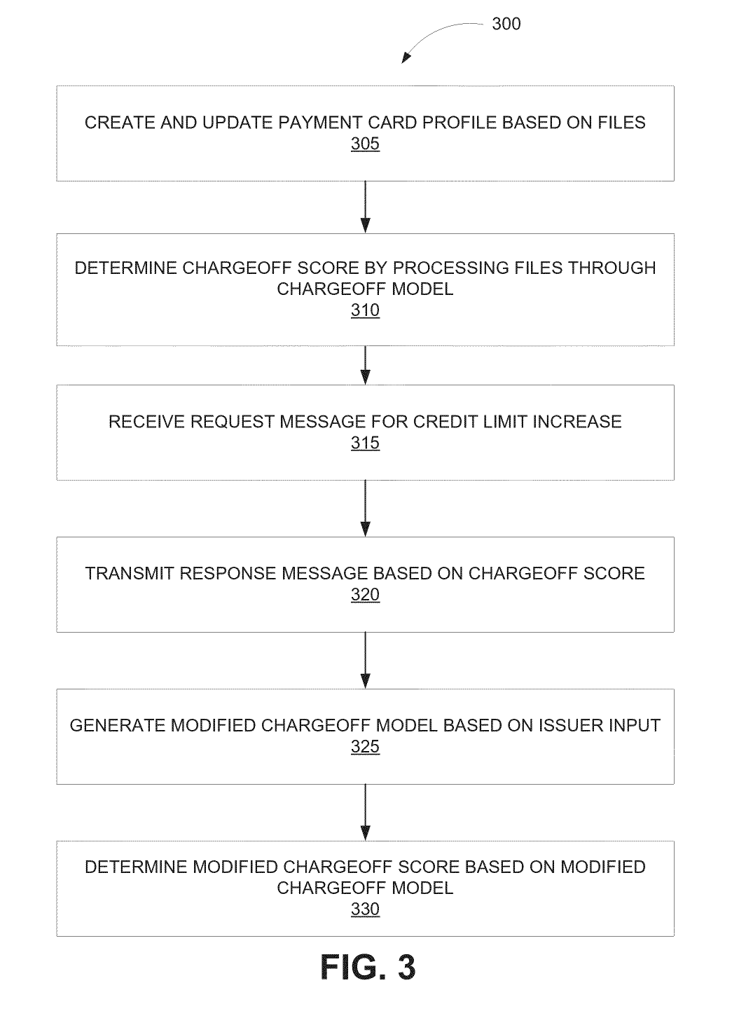

The hosted online platform may include a Graphical User Interface (“GUI”) customized for subject issuer 110 (e.g., private label portals for particular banks), and may allow for subject issuer 110 to build chargeoff profiles that may be associated with customized chargeoff models. The GUI may receive input from the subject issuer by way of touchscreen, mouse, keystroke, and the like. In other words, memory module 106 and the store computer program code may be further configured to, with processor 108, cause server 104 to generate a modified chargeoff model based on subject issuer input (e.g., at operation 325 of method 300 shown in FIG. 3 and discussed below). The modified chargeoff model may be used to determine a modified chargeoff score (e.g., at operation 330 of method 300 shown in FIG. 3 and discussed below), and may be associated with a chargeoff profile. The modified chargeoff model may include, for example, different rules than the chargeoff module, may include different weightings for each chargeoff rule, and so on. Moreover, a subject issuer may create a number of modified chargeoff models associated with chargeoff profiles for different types of payment cards and accounts associated therewith. Chargeoff profiles are described below with regard to additional implementations of the disclosure.

The hosted online platform may also allow subject issuer 110 to submit CLI requests and receive CLI responses in real-time, and may allow subject issuer 110 to vary chargeoff rule parameter values extracted from the payment profile information to determine guidance that a cardholder may follow in order to reduce the chargeoff risk for the cardholder (e.g., by decreasing the average balance or by increasing the monthly payment, etc.).

In one embodiment of the disclosure, having maintained a set of real-time chargeoff scores, payment network 102, by way of server 104, may respond to the CLI request message in real-time (e.g., with no significant delays other than those typical over communications mediums, networks, and databases). In another embodiment, payment network 102 responds with the subject chargeoff score or suggestions based thereon, and also indicates the date and/or time that the subject chargeoff score was determined.

Server 104, in one embodiment, responds to the CLI request message by generating a CLI response message that payment network 102 transmits over the communication medium to a server or other computing device maintained by subject issuer. The CLI response message may be in the form of e-mail, MMS, chat message, phone call, and the like, and may include a pop-up display on a GUI of the subject issuer. In one example implementation, the CLI response message includes a denial suggestion for the CLI request if the subject chargeoff score is greater than or equal to a predetermined threshold; and the CLI response message includes an approval suggestion for the CLI request if the subject chargeoff score is less than the predetermined threshold. The subject chargeoff score represents a risk of chargeoff for the subject card, as alluded to above.

The subject chargeoff score may be, by way of example, a number between 0 and 1 that represents a probability that any balance accumulated by the subject card will be charged off. To illustrate, the predetermined threshold may be 0.5. In this illustration, when the chargeoff score is 0.5 or greater, payment network 102 generates a CLI response message that suggests denial of the CLI request. In various embodiments, the chargeoff score may be set based on different numbering scales, may be represented graphically, may be fed into analytics that process multiple chargeoff scores (e.g., for issuer risk mitigation and control over different financial instruments and credit vehicles), and so on. In addition, the CLI response message may include a sequential listing of one or more of the chargeoff rules in the chargeoff model according the chargeoff rules' contribution to the chargeoff score, or may include the binary values associated with binary subscores used to compute the chargeoff score, as described in more detail below. Such a CLI response message may facilitate the subject issuer developing an at-a-glance deeper understanding of the risk associated with chargeoff for the subject card.

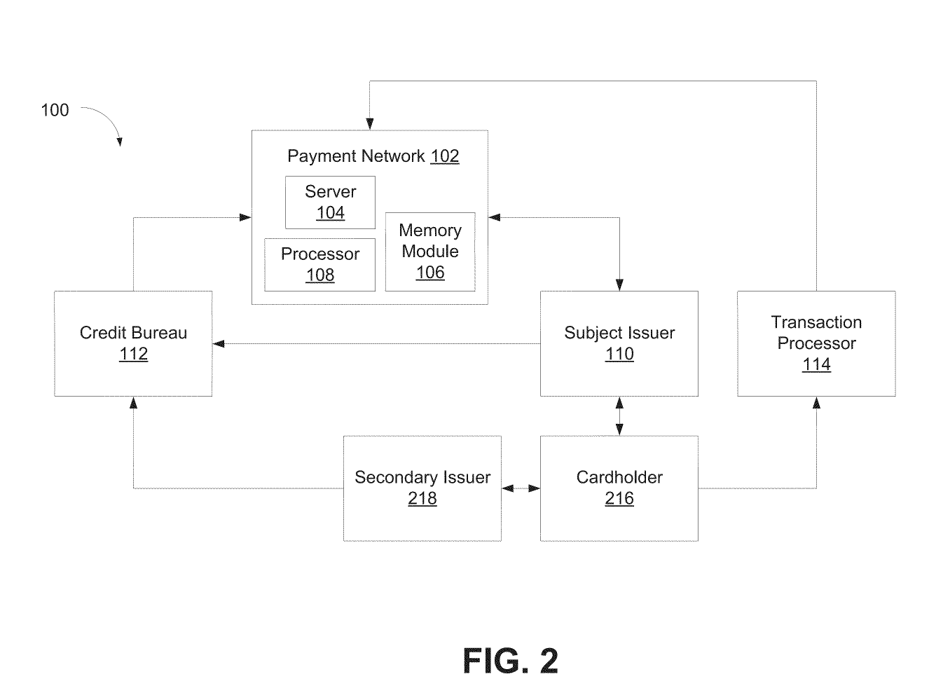

In one example implementation, the subject card is associated with a cardholder and is issued by a subject issuer. Moreover, the risk of chargeoff for the subject card—or the subject chargeoff score—is based on the cardholder's activity associated with the subject card and with one or more secondary cards of the cardholder. For example, FIG. 2 illustrates an embodiment of payment network system 100 that includes secondary issuer 218 and cardholder 216. Cardholder 216 has been described hereinabove—e.g., generally being referred to as cardholder. Secondary cards, in this example implementation, refer to cards issued to the cardholder 216 from one or more secondary issuers 218, which are issuers other than subject issuer 110. Cardholder 216's activity associated with the secondary cards may be captured by server 104 as server 104 parses the credit bureau files and the transaction processor files.

As explained above, credit bureau 112 gathers payment card information from issuers such as secondary issuer 218, and transaction processor 114 gathers payment card information from acquiring banks by way of merchants who accept payment from cardholder 216 (e.g., this is illustrated in FIG. 2 by the arrow connecting cardholder 216 to transaction processor 114). Without the access that payment network system 100 provides to both the credit bureau files and the transaction processor files, when subject issuer 110 receives a CLI request, subject issuer 110 is left to rely on in-house data, or to rely on stale cardholder information, unless subject issuer 110 chooses to be exposed to chargeoff risk. Alternatively, subject issuer 110 may delay responding to the CLI request until a full credit report is obtained. But, as described above, this may result in delay, (e.g., several weeks, if not months), and may cause inconvenience to cardholder 216, as well as requiring mailing and other transaction costs.

In a further embodiment of the disclosure, the chargeoff model may be implemented by subject issuer 110, and subject issuer 110 may thus engage in real-time chargeoff monitoring in-house without the conventional lack of integrated information. For example, subject issuer 110 may partner with credit bureau 112 and transaction processor 114, may construct payment network 102, including servers 104, memory modules 106, and processor 108, and may thus determine chargeoff scores and receive/disposition/respond to CLI requests without relying on a traditional payment network.

FIG. 3 illustrates an example flow diagram of one embodiment of method 300 for implementing real-time chargeoff monitoring, including, but not limited to, for example, across multiple payment cards issued by multiple payment card issuers. Method 300 and related embodiments thereof may be used to integrate payment card information from disparate sources and thereby protect card issuers from exposure to chargeoff risk. Additionally, method 300 may provide card issuers with the ability to make informed, real-time CLI decisions without sacrificing precision related to chargeoff risk (e.g., such sacrifice may come by making CLI decisions based on incomplete or stale data). In addition to streamlining the CLI request/disposition/response process described herein, method 300 also decreases the cost associated with obtaining a robust dataset to accurately manage chargeoff risks related to CLI decisions. For example, method 300 eliminates mailing costs associated with credit-pulls, and may enable automation of the CLI request/disposition/response interaction. Specifically, the operations of method 300 may be used to provide a subject issuer with the ability to disposition CLI requests from the cardholder in real-time, while accounting for chargeoff risks based on information related to the subject card as well as to secondary cards, and while taking advantage of a chargeoff model designed and constructed based a large sample set of robust and timely data.

One embodiment of method 300 includes, at operation 305, creating and updating payment card profiles based on a set of credit bureau data and a set of transaction processor files. Each of the payment card profiles is associated with a payment card. When an issuer requests a CLI for a payment card, the issuer is herein referred to as the subject issuer, and the payment card is herein referred to as the subject card, consistent with the above description. The credit bureau files and the transaction processor files may also be substantially similar to those described above with regard to payment network system 100. As such, information may be extracted from the files and used to create the set of payment card profiles.

By way of example, in various embodiments of method 300, creating and updating the payment card profiles may include parsing the credit bureau files to obtain information associated with the cardholder of the subject card. In such an example, the credit bureau information includes secondary information associated with a set of secondary payment cards held by the cardholder. Such information may include, by way of example, the average balance kept on the payment card, and other of the metrics described above, but gathered across a number of secondary cards issued by secondary issuers (e.g., other than the subject issuer). By further way of example, operation 305 may also include parsing the set of transaction processor files to obtain transaction processor information associated with the set of secondary cards.

Moreover, method 300 may include updating the payment card profile on the fly as additional credit bureau files and transaction processor files are received (e.g., from credit bureaus and transaction processors). The payment card profile may thus be kept current to avoid a cardholder exploiting any information gaps by requesting a CLI and then charging off the balance accumulated thereafter. Additionally, by way of example, multiple payment card profiles of the set may be combined for analysis purposes (e.g., to derive statistical insights associated with financial metrics), or for payment cards commonly held by a single cardholder, or for other purposes. In one example implementation of method 300, the payment card profile is created and updated by a payment network such as payment network 102—and, for example, by server 104, memory module 106, and processor 108.

At operation 310, method 300 includes determining a chargeoff score for the payment card profile by processing the set of credit bureau files and the set of transaction processor files through a chargeoff model. The chargeoff model includes a set of chargeoff rules. In a fashion similar to that described above, the credit bureau files and the transaction processor files may be parsed to determine chargeoff parameter values that may be compared to the set of chargeoff rules in the chargeoff model to determine the chargeoff score, which may represent the sum of a series of subscores, each subscore based on an associated rule. In other words, the chargeoff score may be represented by a number that, in some example implementations, indicates a chargeoff probability for a subject account associated with the subject card. Additionally, as described above, a set of chargeoff scores may be determined, each chargeoff score being associated with one of a set of payment cards.

At operation 315, method 500 involves receiving a request message associated with a CLI request for the subject payment card. CLI request message may be received by payment network 102, for example, and may take on a variety of forms as described above. In one embodiment, the CLI request message is received from an issuer of the subject card, by a payment network server (e.g., server 104) that hosts a website associated with a payment network provider (e.g., MasterCard International). In this illustrative embodiment, the subject issuer (e.g., subject issuer 110) accesses the website hosted by the payment network server to submit a CLI request message and obtain a chargeoff score for the subject card.

In the above embodiment, the payment network server fetches the CLI request message and transmits (e.g., at operation 320) the chargeoff score and any associated response message to the subject issuer via the hosted website (e.g., by a GUI display). In general, operation 320 involves transmitting a response message based on the chargeoff score. For example, if the chargeoff score is below a pre-determined threshold, then the request message may indicate that the CLI request should be approved (e.g., by including a suggestion for approval). In an additional example, if the chargeoff score is greater than or equal to the predetermined threshold, then the request message may indicate that the CLI request should be denied (e.g., by including a suggestion for denial). Moreover, different forms of response messages may be implemented according to the chargeoff score and the rules used to compute the chargeoff score. To illustrate, if one of the chargeoff subscores indicates that there has been a high level of fraudulent activity on the card, then a phone call may be warranted rather than an e-mail. Server 104 may be configured to transmit the response message in response to the CLI request.

At operation 325, one embodiment of method 300 includes generating a modified chargeoff model based on subject issuer input. That is, in this example embodiment, the chargeoff model may be modified, or customized, by the subject issuer. As mentioned above, a subject issuer of a payment mechanism may (e.g., through a user interface such as a GUI) provide input that modifies the chargeoff model for that particular subject issuer. By way of illustration, the subject issuer may vary the weightings associated with one or more of the chargeoff rules; may vary the chargeoff rules themselves, including by adding or deleting chargeoff rules; and/or may create multiple chargeoff models, and assign each to, for example, different amounts (or bands) of CLI requests, different user profiles, different payment cards, and the like. At operation 330, this embodiment of method 300 further includes determining a set of modified chargeoff scores based on the modified chargeoff model. For example, if the subject issuer varies (e.g., at operation 325) the weightings associated with chargeoff rules, operation 330 may involve calculating the one or more chargeoff scores that result from the varied weightings. Further to this example, the modified chargeoff scores may result in a different response messages being transmitted (e.g., at operation 320) in response to the CLI request message received (e.g., at operation 315).

In general, the various operations of method 300 described herein may be accomplished using or may pertain to components or features of the various systems and/or apparatus with their respective components and subcomponents, described herein. Moreover, in various embodiments, features and functions described herein with regard to FIGS. 1 and 2 may be implemented as operations of methods (e.g., method 300), in addition to being implemented as part of systems or apparatus.

FIG. 4 illustrates example computing module 400, which may be used to implement various features of the systems and methods disclosed herein. In one embodiment of the disclosure, computing module 400 includes a non-transitory computer-readable medium having computer-executable program code embodied thereon. The computer-executable program code is configured to cause a computer system (e.g., payment network 102 and components thereof) to receive a set of credit bureau files from one or more credit bureaus and a set of transaction processor files from one or more transaction processors. The computer-executable program code is also configured to cause the computer system to process the credit bureau files, the transaction processor files, and payment card information associated with a set of payment cards, through a rule-based chargeoff model. Based on the output of the rule based chargeoff model, the computer system determines a set of chargeoff scores, each associated with one of the payment cards. The rule-based chargeoff model includes one or more chargeoff rules. Moreover, the computer-executable program code is configured to cause the computer system to receive, from a subject issuer of a subject payment card, a request message associated with a CLI request for the subject payment card.

The computer-executable program code is further configured to cause the computer system to transmit, to the subject issuer, a response message suggesting an approval of the CLI request, if a subject chargeoff score, associated with a subject card selected from the set of payment cards, is less than a predetermined threshold. Moreover, the computer-executable program code is configured to cause the computer system to transmit, to the issuer, a response message suggesting a denial of the CLI request, if the subject chargeoff score is less than the predetermined threshold. In another embodiment, the computer-executable program code is further configured to cause the computer system to generate a customized chargeoff model based on one or more modifications to the chargeoff model by the subject issuer.

In a further example implementation, the chargeoff score is determined based on a sum of weighted binary subscores, each of the weighted binary subscores corresponding to one of the chargeoff rules. The binary subscores are produced based on whether a set of chargeoff rule conditions is met for a set of rule parameter values input to the chargeoff model. By way of illustration only, the set of chargeoff rules may include 11 chargeoff rules, as follows. In various embodiments, however, different numbers of chargeoff rules may be implemented, and the below rules may be modified substantially or slightly.

Rule 1 may equal 1 if the number of times the payment account associated with the subject card is more than 1 day past due in the last 3 months prior to the CLI request exceeds 1, and may equal 0 otherwise. Rule 1 may be weighted by, e.g., 15%, for example. Rule 2 may equal 1 if the card status is not open (e.g., status is lost/stolen), and may equal 0 otherwise. Rule 2 may be weighted by 15%, for example. Rule 3 may equal 1 if utilization of the subject card (e.g., average daily balance divided by credit limit) is greater than 85% or less than 10%, and may equal 0 otherwise. Rule 3 may be weighted by 10%, for example. Rule 4 may equal 1 if the minimum payment amount for the subject card is not met in the last 3 months, and may equal 0 otherwise. Rule 4 may be weighted by 8%, for example. Rule 5 may equal 1 if the number of fraud transactions against the card is more than 3 in the last 3 months, and may equal 0 otherwise. Rule 5 may be weighted by 8%, for example. Rule 6 may equal 1 if a revolving credit balance for the subject card is about 75% of the credit limit, and may equal 0 otherwise. Rule 6 may be weighted by 5%, for example. Rule 7 may equal 1 if the cardholder has missed at least one payment for secondary cards from secondary issuers in the last 3 months, and may equal 0 otherwise. Rule 7 may be weighted by 10%, for example. Rule 8 may equal 1 if the number of hits against the subject cardholder is more than 3 in the last 3 months, and may equal 0 otherwise. Rule 8 may be weighted by 5%, for example. Rule 9 may equal 1 if the number of installment loan closures and bankruptcies and chargeoff occurrences across different financial institutions and secondary issuers is more than 3 in the last 6 months, and may equal 0 otherwise. Rule 9 may be weighted by 10%, for example. Rule 10 may equal 1 if a credit bureau reports (or indicates by the credit bureau file) that the subject cardholder risk score is less than 500, and may equal 0 otherwise. Rule 10 may be weighted by 10%, for example. Rule 11 may equal 1 if, based on estimated income, the cardholder has a relatively high average balance on the subject card or a relatively low balance on the subject card (e.g., greater than 60% or less than 10%), and may equal 0 otherwise. Rule 11 may be weighted by 4%, for example.

The weighted binary subscores in the above illustrative example, if all conditions are met, would add up to a chargeoff score of 1.00 (e.g., the sum of the output of each rule multiplied by the weighting of each rule), indicating a probability that the cardholder is a chargeoff risk. Of course, one of skill in the art, upon reading the present disclosure, will recognize the myriad variations on the above chargeoff rules and associated rule weightings that are possible and that may provide further benefits to those disclosed hereinabove.

For example, one embodiment includes one or more additional rules related to the size of the requested CLI (as an absolute or relative to exist credit limit or other metrics) and/or the granted CLI. Further, the size of the requested CLI may affect one or more of the rule weightings. This may be because generally, for example, issuers tend to avoid risk, and in particular when there is a large amount of money at stake. As such, the subject chargeoff module may be made adaptive based on the CLI amount requested, and/or based on variations thereon. A further embodiment includes a chargeoff rule that takes into account cardholder 216's spend/purchase activity, payment activity, change of delinquency, and so forth, after cardholder 216 receives a CLI.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 4. Various embodiments are described in terms of this example computing module 400. After reading this description, it will become apparent to a person skilled in the relevant art how to implement the application using other computing modules or architectures.

Referring now to FIG. 4, computing module 400 may represent, for example, computing or processing capabilities found within desktop, laptop, notebook, and tablet computers; hand-held computing devices (tablets, PDA's, smart phones, cell phones, palmtops, smart-watches, smart-glasses etc.); mainframes, supercomputers, workstations or servers; or any other type of special-purpose or general-purpose computing devices as may be desirable or appropriate for a given application or environment. Computing module 400 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 400 might include, for example, one or more processors, controllers, control modules, or other processing devices, such as a processor 404. Processor 404 might be implemented using a general-purpose or special-purpose processing engine such as, for example, a microprocessor, controller, or other control logic. In the illustrated example, processor 404 is connected to a bus 402, although any communication medium can be used to facilitate interaction with other components of computing module 400 or to communicate externally.

Computing module 400 might also include one or more memory modules, simply referred to herein as main memory 408. For example, random access memory (“RAM”) or other dynamic memory might be used for storing information and instructions to be executed by processor 404. Main memory 408 might also be used for storing temporary variables or other intermediate information during execution of instructions to be executed by processor 404. Computing module 400 might likewise include a read only memory (“ROM”) or other static storage device coupled to bus 402 for storing static information and instructions for processor 404.

The computing module 400 might also include one or more various forms of information storage mechanism 410, which might include, for example, a media drive 412 and a storage unit interface 420. The media drive 412 might include a drive or other mechanism to support fixed or removable storage media 414. For example, a hard disk drive, a solid state drive, a magnetic tape drive, an optical disk drive, a CD or DVD drive (R or RW), or other removable or fixed media drive might be provided. Accordingly, removable storage media 414 might include, for example, a hard disk, a solid state drive, magnetic tape, cartridge, optical disk, a CD or DVD, or other fixed or removable medium that is read by, written to or accessed by media drive 412. As these examples illustrate, removable storage media 414 can include a computer usable storage medium having stored therein computer software or data.

In alternative embodiments, information storage mechanism 410 might include other similar instrumentalities for allowing computer programs or other instructions or data to be loaded into computing module 400. Such instrumentalities might include, for example, a fixed or removable storage unit 422 and a storage unit interface 420. Examples of such storage units 422 and storage unit interfaces 420 can include a program cartridge and cartridge interface, a removable memory (for example, a flash memory or other removable memory module) and memory slot, a PCMCIA slot and card, and other fixed or removable storage units 422 and storage unit interfaces 420 that allow software and data to be transferred from removable storage unit 422 to computing module 400.

Computing module 400 might also include communications interface 424. Communications interface 424 might be used to allow software and data to be transferred between computing module 400 and external devices. Examples of communications interface 424 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 424 might typically be carried on signals, which can be electronic, electromagnetic (which includes optical) or other signals capable of being exchanged by a given communications interface 424. These signals might be provided to communications interface 424 via a channel 428. This channel 428 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, main memory 408, storage unit 422, removable storage media 414, and channel 428. These and other various forms of computer program media or computer usable media may be involved in carrying one or more sequences of one or more instructions to a processing device for execution. Such instructions embodied on the medium are generally referred to as “computer program code” or a “computer program product” (which may be grouped in the form of computer programs or other groupings). When executed, such instructions might enable computing module 400 to perform features or functions of the present application as discussed herein.

Although described above in terms of various example embodiments and implementations, it should be understood that the various features, aspects, and functionalities described in one or more of the individual embodiments are not limited in their applicability to the particular embodiments with which they are described, but instead can be applied, alone or in various combinations, to one or more of the other embodiments of the application, whether related to a system, apparatus, or method, whether or not such embodiments are described, and whether or not such features are presented as being a part of a described embodiment. Thus, the breadth and scope of the present application should not be limited by any of the above-described example embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide example instances of the item in discussion, not an exhaustive or limiting list thereof; the terms “a” or “an” should be read as meaning “at least one,” “one or more” or the like; and adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to,” or other like phrases, in some instances will not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of example block diagrams, flow charts, and other illustrations. As will become apparent to one of ordinary skill in the art after reading this document, the illustrated embodiments and their various alternatives can be implemented without confinement to the illustrated examples. For example, block diagrams and their accompanying descriptions should not be construed as mandating a particular architecture or configuration or sequence of operations.

While various embodiments of the present disclosure have been described above, it should be understood that these embodiments have been presented by way of example only, and not by way of limitation. Likewise, the various diagrams and figures herein may depict an example architectural or other configuration for various embodiments of the disclosure, which is done to aid in understanding the features and functionality that can be included in the disclosure. The disclosure is not restricted to the illustrated example architectures or configurations, but disclosed features may be implemented using a variety of alternative architectures and configurations. Indeed, it will be apparent to one of skill in the art, upon reading this disclosure, how alternative functional, logical, or physical partitioning and configurations can be implemented to implement the features of the present disclosure. Also, a multitude of different constituent module names other than those depicted herein can be applied to the various partitions. Additionally, with regard to flow diagrams, operational descriptions, and method claims and associated operations, the order in which the operations are presented herein does not mandate that various embodiments be implemented to perform the recited functionality in the same order, unless the context dictates otherwise.

Although the disclosure is described above in terms of various example embodiments and implementations, it should be understood that the various features, aspects, and functionalities described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described example embodiments.

What is claimed is:

1. A payment network for real-time chargeoff monitoring, the payment network comprising:
a server; and
at least one memory module storing computer program code, wherein the at least one memory module and the stored computer program code are configured to, with at least one processor, cause the server to:
receive a set of credit bureau files and a set of transaction processor files;
process the credit bureau files, the transaction files, and payment card information associated with a set of payment cards, through a chargeoff model to determine a set of chargeoff scores, each of the chargeoff scores associated with at least one of the payment cards; and
receive a credit-limit-increase request message comprising a credit-limit increase request for a subject card selected from the set of payment cards.

2. The payment network of claim 1, wherein the at least one memory module and the computer program code are further configured to, with the at least one processor, cause the server to generate a credit-limit-increase response message based on the chargeoff score.

3. The payment network of claim 2, wherein the credit-limit-increase request message is received from a subject issuer that issued the subject card to a subject cardholder; wherein the credit-limit-increase response message comprises a denial suggestion for the credit-limit increase request if a subject chargeoff score is greater than or equal to a predetermined threshold, the subject chargeoff score associated with the subject card; and wherein the credit-limit-increase response message comprises an approval suggestion for the credit-limit-increase request if the subject chargeoff score is less than the predetermined threshold.

4. The payment network of claim 1, wherein each of the chargeoff scores represents a risk of chargeoff for the at least one associated payment cards.

5. The payment network of claim 4, wherein the risk of chargeoff is based on the subject cardholder's activity associated with the subject card and further is based on the subject cardholder's activity associated with one of more secondary cards of the subject cardholder; and wherein the one or more secondary cards were issued by one or more issuers other than the subject issuer.

6. The payment network of claim 1, wherein the chargeoff model receives as input a set of chargeoff parameter values associated with one of the payment cards, and produces as output the chargeoff score the set of payment cards.

7. The payment network of claim 1, wherein the at least one memory module and the stored computer program code are further configured to, with the at least one processor, cause the server to receive the credit-limit-increase request message via a hosted online platform.

8. The payment network of claim 7, wherein the hosted online platform comprises a graphical user interface that receives input from a subject issuer.

9. The payment network of claim 8, wherein:
the server receives the credit-limit-increase request message from the subject issuer; and
the at least one memory module and the stored computer program code are further configured to, with the at least one processor, cause the server to:
generate a modified chargeoff model based on the input from the subject issuer; and
determine a set of modified chargeoff scores based on the modified chargeoff model.

10. A method for real-time chargeoff monitoring, the method comprising:
creating and updating a set of payment card profiles based on a set of credit bureau files and a set of transaction files, each of the payment card profiles associated with a payment card;
determining a chargeoff score for each the payment card profiles by processing the set of credit bureau files and the set of transaction files through a chargeoff model comprising a set of chargeoff rules;
receiving a request message associated with a credit-limit-increase request for a subject card selected from the set of payment cards; and
transmitting, in response to the credit-limit-increase request, a response message based on the chargeoff score associated with the subject card.

11. The method of claim 10, wherein creating and updating the payment card profile comprises:
parsing the set of credit bureau files to obtain credit bureau information associated with a cardholder of the subject card, the credit bureau information comprising secondary information associated with a set of secondary cards issued to the cardholder;
parsing the set of transaction files to obtain transaction processor information associated with the set of secondary cards.

12. The method of claim 11, wherein the request message is received from a subject issuer that issued the subject card; and wherein the set of secondary cards were issued by one or more issuers other than the subject issuer.

13. The method of claim 10, wherein the response message comprises a suggestion for approval of the credit-limit-increase request if the chargeoff score is less than or equal to a chargeoff threshold; and wherein the response message comprises a suggestion for denial of the credit-limit-increase if the chargeoff score is greater than the chargeoff threshold.

14. The method of claim 10, wherein the chargeoff score comprises a number that indicates a chargeoff probability for a balance maintained in an account associated with the payment card profile.

15. The method of claim 14, wherein the response message comprises the chargeoff score.

16. The method of claim 10, wherein the request message is received by a payment network server that hosts a website associated with a provider of the payment network; wherein the request message is received from subject issuer that issued the subject card; and wherein the response message is transmitted, by the payment network server, to the subject issuer.

17. A non-transitory computer-readable medium having computer-executable program code embodied thereon, the computer-executable program code configured to cause a computer system to:
receive a set of credit bureau files and a set of transaction processor files;
process the credit bureau files, the transaction files, and payment card information associated with a set of payment cards, through a ruled-based chargeoff model to determine a chargeoff score for each of the payment cards, the rule-based chargeoff model comprising one or more chargeoff rules;
receive, from a subject issuer that issued a subject card, a request message associated with a credit-limit-increase request for the subject card, the subject card selected from the set of payment cards;
transmit, to the subject issuer, a response message suggesting an approval of the credit-limit-increase request, if the chargeoff score for the subject card is less than a predetermined threshold; and
transmit, to the subject issuer, a response message suggesting a denial of the credit-limit-increase request, if the chargeoff score for the subject card is greater than or equal to the predetermined threshold.

18. The non-transitory computer-readable medium of claim 17, wherein the computer-executable program code is further configured to cause the computer system to generate a customized chargeoff model based on one or more modifications to the chargeoff model by the subject issuer.

19. The non-transitory computer-readable medium of claim 17, wherein the chargeoff score for each of the payment cards is a number between 0 and 1, and wherein the chargeoff score represents a probability of chargeoff associated with the credit-increase-request.

20. The non-transitory computer-readable medium of claim 17, wherein the chargeoff score for each of the payment cards is determined based on a sum of weighted binary subscores, each of the weighted binary subscores corresponding to one of the chargeoff rules.
